(19) United States
(12) Patent Application Publication
(10) Pub. No.: US 2021/0301873 A1
(43) Pub. Date: Sep. 30, 2021

(54) HIGH SPEED BALL BEARING

(71) Applicant: SCHAEFFLER TECHNOLOGIES AG & CO. KG, Herzogenaurach (DE)

(72) Inventor: Daniel Wuerdinger, Troy, MI (US)

(73) Assignee: SCHAEFFLER TECHNOLOGIES AG & CO. KG, Herzogenaurach (DE)

(21) Appl. No.: 16/833,717

(22) Filed: Mar. 30, 2020

(51) Int. Cl. F16C 33/38; F16C 19/16; F16C 43/06

(52) U.S. Cl. CPC F16C 33/3887; F16C 43/065; F16C 19/16

(57) ABSTRACT

A high-speed ball bearing utilizes a two-piece cage. Each of the two cage halves have a set of posts and a set of holes located circumferentially between the half pockets. The posts are long enough that they stick out from the corresponding holes after the cage halves are mated together. Heat is applied to the ends of the posts, causing them to form vulcanized bonds with the surrounding material of the opposite cage half. These bonds reliably hold the cage halves together even at high rotational speeds.

### TECHNICAL FIELD

The disclosure applies to the field of ball bearings. In particular, a cage suitable for high speed applications and a corresponding method of assembly are disclosed.

### BACKGROUND

FIG. 1 is a cross section of a ball bearing. The bearing includes an inner ring 12 and an outer ring 14 which are concentric about an axis of rotation. A set of rollers 16, in this case balls, separate the inner race and the outer ring. The surface of each ring which is contacted by the rollers is called a race. The rollers facilitate relative rotation of the inner ring and the outer ring with low friction. The rollers may transmit radial and axial forces between the inner ring and the outer ring. The rollers are circumferentially spaced relative to one another by a cage 18.

### SUMMARY

A method of fabricating a high-speed bearing includes forming two cage halves, mating them, and heating the ends of post. The first and second cage halves each define a plurality of half-pockets, a plurality of posts extending axially between adjacent half-pockets, and a plurality of holes between adjacent half-pockets. The number of posts on each cage half may be equal to the number of half-pockets defined in each cage half. The first cage half and the second cage half may be substantially geometrically identical. Rollers, such as balls, may first be inserted between inner and outer rings and then inserted into the half-pockets of the first cage half before mating the first cage half to the second cage half. The first cage half is mated to the second cage half such that ends of the posts of the first cage half extend through the holes of the second cage half and such that ends of the posts of the second cage half extend through the holes of the first cage half. The rollers are retained in pockets formed by pairs of corresponding half-pockets. Heating the ends of the posts of the first cage half and the ends of the posts of the second cage half forms vulcanized bonds between the posts and the adjacent material of the opposite cage half.

A high-speed bearing includes first and second cage halves. Each cage half defines a plurality of half-pockets, a plurality of posts extending axially between adjacent half-pockets, and a plurality of holes between adjacent half-pockets. The number of posts on each cage half may be equal to the number of half-pockets defined in each cage half. The two cage halves may be substantially geometrically identical. The first cage half is mated to the second cage half such that ends of the posts of the first cage half extend through the holes of the second cage half and such that ends of the posts of the second cage half extend through the holes of the first cage half. The ends of the posts of the first cage half and the ends of the second cage half are bonded to adjacent material of the opposite cage half with vulcanized bonds. Rollers, such as balls, may be retained in pockets formed by pairs of corresponding half-pockets. The rollers may separate an inner ring from an outer ring.

### BRIEF DESCRIPTION OF THE DRAWINGS

FIG. 1 is a cross section of a typical ball bearing.

FIG. 2 is an exploded view of ball rollers and a bearing cage formed from two half cages.

FIG. 3 is a pictorial view of the cage and rollers of FIG. 2 after the cage halves are mated.

FIG. 4 is an end view of the cage and rollers of FIG. 3.

FIG. 5 is a pictorial view of the cage and rollers after the two cage halves have been fastened by heating protruding post ends.

FIG. 6 is a flow chart for a method of producing a bearing having the rollers and cage of FIG. 5.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

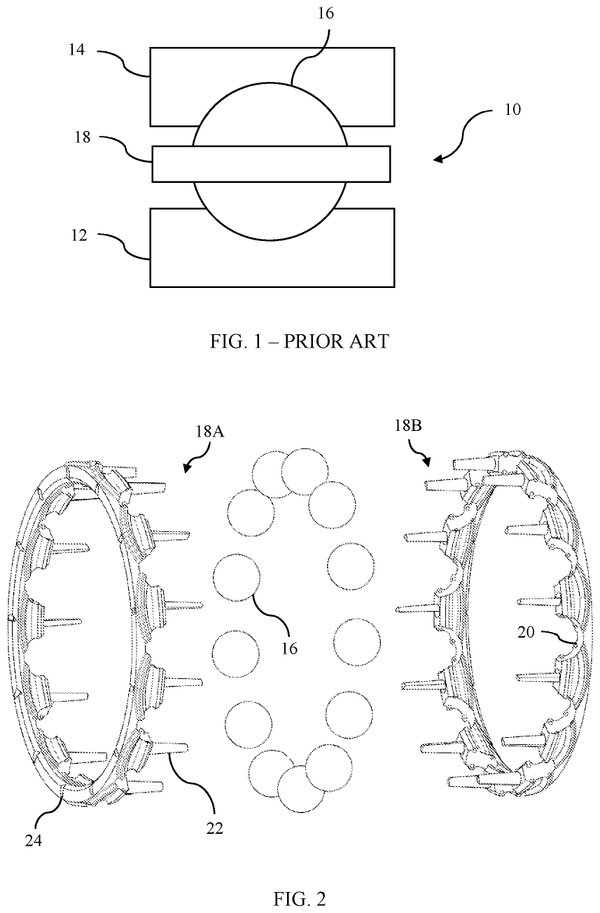

FIG. 2 is an exploded view of two cage halves 18A and 18B and a set of ball rollers 16. Cage halves 18A and 18B, as shown, are identical to one another. Each cage half defines a set of half-pockets 20. Once assembled, the half-pockets 20 form pockets to retain each of the rollers 16. Each cage half includes a number of posts 22. Each post is located between adjacent half-pockets. As shown, the number of posts is equal to the number of half-pockets, although it is possible to have fewer posts than half-pockets. For example, some embodiments may have a post for every two half-pockets. Each cage half also includes a number of holes 22, which are located between adjacent half-pockets. The holes of each cage half are shaped to accept the posts of the opposite cage half.

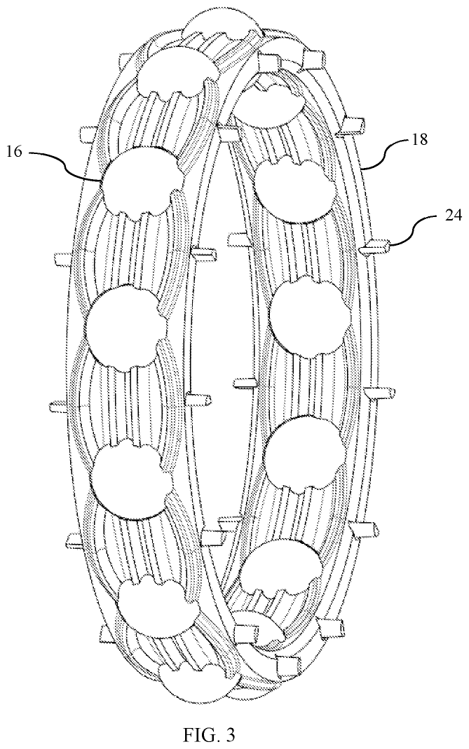

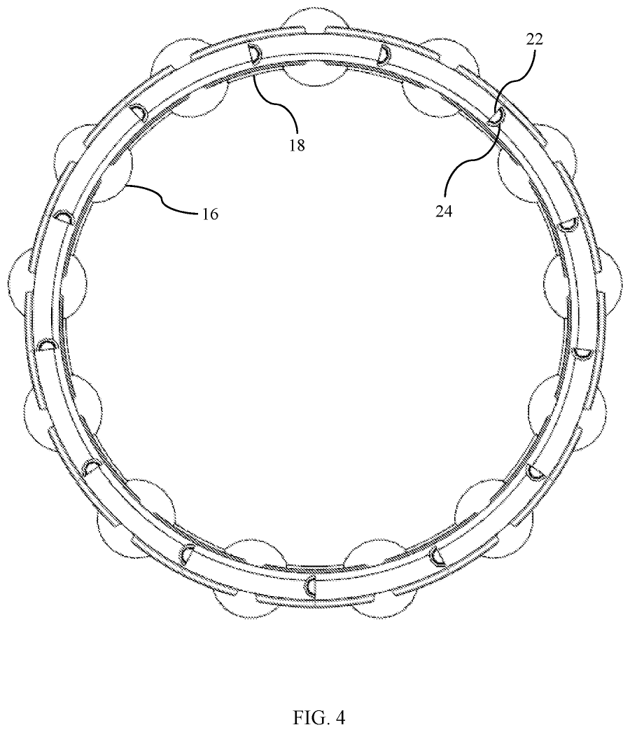

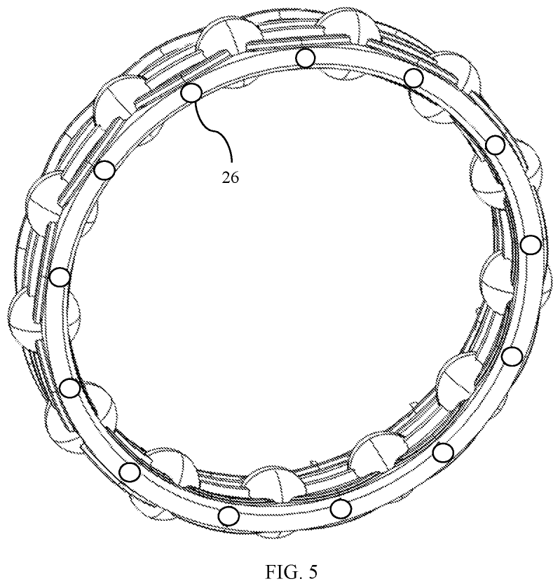

FIG. 3 shows the cage 18 and the rollers 16 after the cage halves 18A and 18B have been mated together. Notice that the ends of each of the posts 24 stick out slightly from the corresponding holes 22. FIG. 4 is an end view of the mated cage 18 and rollers 16. After the cage halves are joined, the tips of the posts are heated such that they form vulcanized joints 26 with the opposite cage half as shown in FIG. 5.

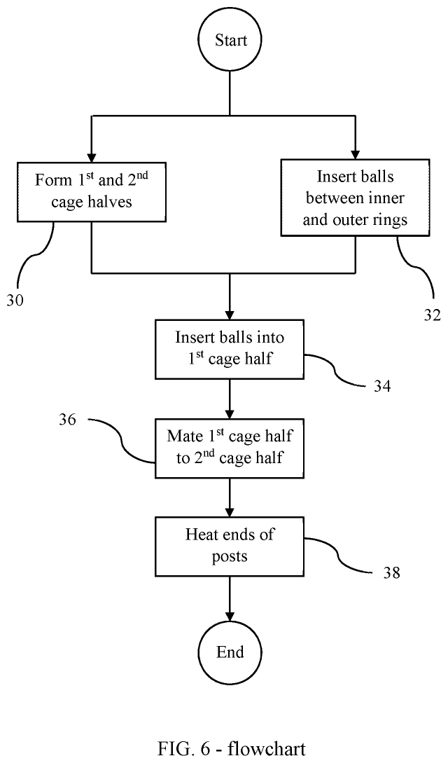

FIG. 6 illustrates a method of producing bearings having cages as illustrated in FIG. 5. At 30, the cage halves are fabricated, for example by injection molding. To simplify production, it is preferable but not mandatory that the two cage halves be identical. At 32, the ball rollers are inserted between inner and outer rings. This may be accomplished, for example, by offsetting the rings to create a sufficiently large gap on one side and then distributing the balls evenly around the circumference after they have been inserted. At 34, the balls are inserted into the half pockets of one of the cage halves. At 36, the two cage halves are mated to one another with the balls in place. Finally, at 38, the protruding ends of the posts are heated. The heating melts the plastic, which then re-hardens. The cage halves are held together in two ways. First, the re-hardened ends are larger in cross-section than the holes, such that they act like plastic rivets. Second, the plastic volcanically bonds with the plastic of the other cage half as it re-hardens.

A symmetrical cage tends to perform significantly better compared with an asymmetrical design during high speed operation for a number of reasons. The failure mechanism of an asymmetrical high speed cage is either cage-ejection at high speed or high acceleration or a fatigue failure due to high stresses in the pocket of the cage. The proposed cage design eliminates both of these concerns. Cage ejection is not possible due to the vulcanized bond and riveting mechanism which is formed during the assembly process and the overall stress level in the cage pockets is significantly lower due to even expansion under significant centrifugal forces.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

What is claimed is:

1. A method of fabricating a high-speed bearing, the method comprising:
forming first and second cage halves, each cage half defining a plurality of half-pockets, a plurality of posts extending axially between adjacent half-pockets, and a plurality of holes between adjacent half-pockets;
mating the first cage half to the second cage half such that ends of the posts of the first cage half extend through the holes of the second cage half and such that ends of the posts of the second cage half extend through the holes of the first cage half; and
heating the ends of the posts of the first cage half and the ends of the posts of the second cage half.

2. The method of claim 1 wherein heating the ends of the posts forms vulcanized bonds between the posts and the adjacent material of the opposite cage half.

3. The method of claim 1 further comprising inserting rollers into the half-pockets of the first cage half before mating the first cage half to the second cage half such that the rollers are retained in pockets formed by pairs of corresponding half-pockets.

4. The method of claim 3 further comprising inserting the rollers between and outer ring and an inner ring before inserting the rollers into the half-pockets of the first cage half.

5. The method of claim 3 wherein the rollers are balls.

6. The method of claim 1 wherein the number of posts on each cage half is equal to the number of half-pockets defined in each cage half.

7. The method of claim 1 wherein the first cage half and the second cage half are substantially geometrically identical.

8. A high-speed bearing comprising:
first and second cage halves, each cage half defining a plurality of half-pockets, a plurality of posts extending axially between adjacent half-pockets, and a plurality of holes between adjacent half-pockets;
wherein the first cage half is mated to the second cage half such that ends of the posts of the first cage half extend through the holes of the second cage half and such that ends of the posts of the second cage half extend through the holes of the first cage half; and
wherein the ends of the posts of the first cage half and the ends of the second cage half are bonded to adjacent material of the opposite cage half with vulcanized bonds.

9. The bearing of claim 8 further comprising rollers retained in pockets formed by pairs of corresponding half-pockets.

10. The bearing of claim 9 further comprising an inner ring and an outer ring separated by the rollers.

11. The bearing of claim 9 wherein the rollers are balls.

12. The bearing of claim 8 wherein the number of posts on each cage half is equal to the number of half-pockets defined in each cage half.

13. The bearing of claim 8 wherein the first cage half and the second cage half are substantially geometrically identical.
